(19) United States
(12) Patent Application Publication
(10) Pub. No.: US 2007/0272458 A1
(43) Pub. Date: Nov. 29, 2007

(54) Wheel Supporting and Driving Device

(75) Inventors: Takao Taniguchi, Tokyo (JP); Nobuaki Miki, Tokyo (JP); Takumi Tachibana, Tokyo (JP)

Correspondence Address: BACON & THOMAS, PLLC, 625 SLATERS LANE, FOURTH FLOOR, ALEXANDRIA, VA, 22314, US

(73) Assignee: KABUSHIKIKAISHA EQUOS RESEARCH, Tokyo (JP)

(21) Appl. No.: 11/663,156

(22) PCT Filed: Dec. 7, 2005
(86) PCT No.: PCT/JP05/22450

§ 371 Date: Jul. 25, 2007

(30) Foreign Application Priority Data
Dec. 9, 2004 (JP) 2004-356225

(51) Int. Cl. B60K 1/00

(52) U.S. Cl. 180/65.5; 180/348; 180/369; 701/70

(57) ABSTRACT

A wheel supporting and driving device, comprising a motor (20) fixed to a vehicle body (12), a drive gear (24) coaxially rotated by the motor (20), and a driven gear (30) coaxially and integrally rotated with a wheel (14) which are installed in a vehicle. The drive gear (24) is rotated by the motor (20) around a rotating center decentered from the rotating center of the wheel (14) in a direction crossing perpendicularly to the vertical direction. Also, the device comprises a suspension arm (40) connecting the drive gear (24) to the driven gear (30) in the state of the driven gear (30) reciprocatingly swingable around the rotating center of the drive gear (24) and a suspension spring (50) elastically connecting the wheel (14) to the vehicle body (12).

The disclosure of PCT International Publication No. WO 2006/062125 A1 filed on Dec. 7, 2005 including the specification, drawings and abstract is incorporated herein by reference in its entirety.

### BACKGROUND OF THE INVENTION

1. Field of the Invention

The present invention relates to a technology in which wheels are supported in a vehicle so as to be able to move vertically with respect to the vehicle body, and each of the wheels is driven by a motor, and in particular, relates to a technology that simplifies a structure that realizes the ability to support the wheels and the ability to drive the wheels.

2. Description of the Related Art

A vehicle in which wheels are supported so as to be able to move vertically with respect to a vehicle body and these wheels are driven by a motor is already known (refer, for example, to Japanese Patent Application Publication No. JP-A-H6-48192).

In this type of vehicle, there is a demand to realize, for each of these wheels, an ability for the wheel to be supported so as to be able to move at least vertically and an ability for the wheel to be driven by a motor. The former ability is referred to as the “suspension ability”, in which a wheel is suspended on a vehicle body.

In this type of vehicle, conventionally a motor is mounted in a wheel only in order to drive the wheel, and this wheel is not designed such that this motor can contribute to the suspension ability. Thus, in this conventional vehicle, it is difficult to simplify the structure that would be necessary to realize the ability that drives the vehicle and the suspension ability.

Furthermore, in this conventional vehicle, the motor is fixed to the hub of the wheel, and the motor moves vertically accompanying the vertical movement of the wheel. Thus, in this conventional vehicle, the weight of the motor contributes to the unsprung mass of the vehicle, and as a result, it is difficult to reduce this unsprung mass.

### SUMMARY OF THE INVENTION

In consideration of the circumstances described above, in a technology in which wheels are supported in a vehicle to so as to be able to move vertically with respect to the vehicle body and in which each wheel is driven by a motor, it is an object of the present invention to simplify the structure that realizes the ability that supports a wheel and the ability that drives this wheel.

Each of the modes described below is obtained by the present invention. Each of the modes is described in separate sections, numbers are attached to each of the sections, and as necessary, the numbers of other sections are quoted. This is in order to simplify the understanding of portions of the technical features that can be adopted by the present invention and combinations thereof, and these technical features that can be adopted by the present invention and combinations thereof should not be understood to be limited by the following modes. That is, although not disclosed in the following modes, it should be understood that the technological features disclosed in the present specification can be suitably extracted and used as technical features of the present invention.

Furthermore, it should be understood that disclosing the modes in a format in which each section cites the numbers of the other sections does not necessarily imply that the technical features disclosed in each section are prevented from being separate from the technical features disclosed in other sections and being made independent, and it should be understood that the technical features disclosed in each of the sections can be suitably made independent depending on the characteristics thereof.

(1) In a first aspect of the present invention, a wheel supporting and driving apparatus that is provided in a vehicle is one in which a wheel is supported so as to be able to move vertically with respect to a vehicle body, and the wheel is driven. The wheel supporting and driving apparatus includes a motor that is supported on the vehicle body and a first rotating body that is rotated by this motor; a second rotating body that is coaxially and integrally rotated with the wheel; a first linking mechanism in which the first rotating body and the second rotating body are linked together such that the first rotating body and the second rotating body apply a rotating force to each other while a center of rotation of the first rotating body serves as a center of swinging, and the second rotating body reciprocatingly swings around this center of swinging; and a second linking mechanism by which the wheel and the vehicle body are linked together elastically. The first rotating body is rotated by the motor around a center of rotation that is decentered from the center of rotation of the wheel in a direction crossing perpendicularly to the vertical direction.

(2) In a second aspect of the present invention, the wheel supporting and driving apparatus according to the first aspect is one in which the first rotating body is a drive gear and the second rotating body is a driven gear that meshes with the drive gear and is rotated. The first linking mechanism includes suspension arms that link the drive gear and the driven gear together in a meshed state such that the driven gear can reciprocatingly swing around the drive gear so as to define a constant radius; and the second linking mechanism includes a suspension spring that elastically links the wheel and the vehicle body together.

(3) In a third aspect of the present invention, the wheel supporting and driving apparatus according to the first or second aspect is one that includes a sun gear that rotates coaxially and integrally with a wheel; a ring gear that rotates coaxially with and relative to the wheel; a plurality of pinion gears that are disposed so as to be arranged on a circle that is coaxial with the sun gear, and the plurality of pinion gears mesh with the outer teeth of the sun gear and mesh with the inner teeth of the ring gear; and a carrier that retains the plurality of pinion gears such that the relative positional relationships of centers of rotation of the plurality of pinion gears are maintained. A planetary gear mechanism is formed by the sun gear, the ring gear, the plurality of pinion gears, and the carrier. The first rotating body is formed as one among the plurality of pinion gears and the second rotating body is structured as the sun gear.

(4) In a fourth aspect of the present invention, the wheel supporting and driving apparatus according to the first or second aspect is one that includes a sun gear that rotates coaxially and integrally with the wheel; a ring gear that rotates coaxially with and relative to the wheel; a plurality of pinion gears that are disposed so as to be arranged on a circle that is coaxial with the sun gear, and the plurality of pinion gears mesh with the outer teeth of the sun gear and mesh with the inner teeth of the ring gear; and a carrier that retains the plurality of pinions such that the relative positional relationships of the centers of rotation of the plurality of pinions are maintained. A planetary gear mechanism is formed by the sun gear, the ring gear, the plurality of pinion gears, and the carrier. The first rotating body is structured as one among the plurality of pinion gears and the second rotating body is structured as a ring gear.

(5) In a fifth aspect of the present invention, the wheel supporting and driving apparatus according to any one of the first to fourth aspects is one in which the motor is linked coaxially with the first rotating body.

(6) In a sixth aspect of the present invention, the wheel supporting and driving apparatus according to the fifth aspect is one in which the wheel is a nonsteerable wheel that is not steered while steering the vehicle; and the motor and the first rotating body are supported by the vehicle body in a fixed position.

(7) In a seventh aspect of the present invention, the wheel supporting and driving apparatus according to any one of the first to fourth aspects is one in which the wheel is a steerable wheel that is steered while steering the vehicle; and the motor and the first rotating body are supported by the vehicle body so as to rotate integrally with the steerable wheel while steering the vehicle.

(8) In an eighth aspect of the present invention, the wheel supporting and driving apparatus according to any one of the first to seventh aspects is one which includes a control apparatus that controls the output torque of a motor by controlling a drive signal sent to the motor.

(9) In a ninth aspect of the present invention, the wheel supporting and driving apparatus according to the eighth aspect is one in which the control apparatus includes a damping characteristic control unit that controls damping characteristics of the wheel with respect to the vehicle body during vertical movement by controlling swinging characteristics around the center of swinging of the wheel via a motor.

(10) In a tenth aspect of the present invention, the wheel supporting and driving apparatus according to the eighth or ninth aspect is one in which the control apparatus includes a wheel drive torque control unit that controls the drive torque around the center of rotation of the wheel via the motor.

In the wheel supporting and driving apparatus according to the first aspect, the wheel can reciprocatingly swing around the center of rotation of the first rotating body, and the second rotating body is linked to the first rotating body by the first linking mechanism.

The second rotating body can rotate along with the wheel. In such a structure, the first rotating body is rotated by the motor around a center of rotation that is decentered from the center of rotation of the wheel in a direction crossing perpendicularly to the vertical direction.

Therefore, in this wheel supporting and driving apparatus, the rotation of the wheel (autorotation) and the reciprocating swinging (revolution) around the center of rotation of the first rotating body of the same wheel can be realized by the same motor. The rotation of the wheel contributes to the travel (drive) of the vehicle, whereas the reciprocating swinging of the wheel contributes to the suspension ability of the vehicle. The characteristics of this reciprocating swinging can be controlled by the motor. Furthermore, in this wheel supporting and driving apparatus, the wheel is elastically linked by the second linking mechanism.

Thus, according to this wheel supporting and driving apparatus, it is possible to realize a suspension ability in which the vehicle body is suspended by the wheels so as to be able to move at least vertically by the cooperation of the reciprocating swinging of the wheel and the controllability of the characteristics thereof by the motor, the wheel being elastically linked to the vehicle body.

Specifically, according to this wheel supporting and driving apparatus, it becomes possible to realize both the ability of driving the vehicle and the suspension ability together by the same motor, and thus, the structures that are necessary to realize these abilities can be easily simplified in comparison to the case in which these abilities must be realized by separate actuators.

Furthermore, in this wheel supporting and driving apparatus, the motor that realizes the rotation and the reciprocating swinging of the wheel is supported by the vehicle body, and is not fixed to the wheel.

Therefore, according to this wheel supporting and driving apparatus, because the motor does not move vertically accompanying the vertical movement of the wheel, the unsprung mass of the vehicle can be easily reduced in comparison to the case in which the motor is fixed to the wheel.

In addition, in this wheel supporting and driving apparatus, the locus that is defined by the center of rotation of the wheel accompanying the reciprocating swinging of the second rotating body, that is, the locus of motion of the wheel when viewing the wheel from the side, differs depending on the whether the position of the center of rotation of the first rotating body, which coincides with the center of swinging of the second rotating body, is invariable or variable when viewing the vehicle from the side.

Specifically, in the case in which, for example, the position of this center of swinging is constant when viewing the vehicle from the side, the locus of movement of the wheel defines an arc. In contrast, in the case in which the position of this center of swinging is variable in the longitudinal direction of the vehicle when viewing the wheel from the side, the locus of motion of the wheel is determined by the direction that is restricted by the vehicle body or an immobilizing member such that the center of rotation of this wheel is able to move. For example, if the direction in which the center of rotation of the wheel can move is restricted so as to coincide with the vertical direction of the vehicle, the locus of motion of this wheel is formed in the vertical direction of the vehicle. In this case, irrespective of the reciprocating swinging around the center of rotation of the first rotating body, the wheel is subject to a substantially linear reciprocation in the vertical direction of the vehicle.

Even in the case in which the first rotating body is attached to the vehicle body such that the position of the center of rotation of the first rotating body varies in the longitudinal direction of the vehicle when viewing the wheel from the side, the unsprung mass of the vehicle (in particular, the mass of the vehicle that corresponds to the inertia in the vertical direction) does not increase more than the case in which the first rotating body is attached to the vehicle body such that the position of the center of rotation of the first rotating body is invariable when viewing the wheel from the side.

Therefore, in the case in which this wheel supporting and driving apparatus is implemented, it is possible to satisfy the demand to optimize the locus of motion of the wheel by separating this from the problem that the unsprung mass of the vehicle increases.

In addition, this wheel supporting and driving apparatus can, for example, be implemented in a mode in which the motor and the first rotating body are linked together coaxially or can be implemented in a mode in which the motor and the first rotating body are linked together non-coaxially.

Furthermore, this wheel supporting and driving apparatus can, for example, be implemented in a first mode in which the link between a first rotating body and a second rotating body is carried out by using a gear mechanism, or can be implemented in a second mode in which the link between a first rotating body and a second rotating body is carried out by using an endlessly circulating body (for example, a belt, chain, or the like) that is wrapped around the first rotating body and the second rotating body.

Both the first and second modes are classified as contact-type modes in which power is transferred between a first rotating body and a second rotating body via a contact surface. However, in this wheel supporting and driving apparatus, the link between a first rotating body and a second rotating body can be implemented as a non-contact type mode, such as a mode in which a fluid that is sealed in an enclosed space is used as a pressure transferring medium between the first rotating body and the second rotating body according to a principle that is identical to the principle by which power is transferred, for example, in a fluid-type torque converter.

The “motor” in this section is used so as to be supported by the vehicle body so as to be immobile at least a vertical direction with respect to the vehicle body.

In the wheel supporting and driving apparatus according to the second aspect, the first rotating body and the second rotating body are linked together by using the gear mechanism, and specifically, they are linked together by using a combination of the drive gear and the driven gear that mesh and rotate together. The drive gear and the driven gear are linked together such that the driven gear can reciprocatingly swing around the drive gear so as to define a constant radius due to suspension arms (or suspension links). Furthermore, the wheel and the vehicle are elastically linked together by a suspension spring.

Therefore, according to this wheel supporting and driving apparatus, the suspension ability of the vehicle with respect to this wheel can be realized by the motor that realizes the reciprocating swinging (revolution) of the wheel in addition to the drive (autorotation) of the wheel, and the suspension spring, due to the co-operative action with the suspension arms.

In the wheel supporting and driving apparatus according to the third aspect, the first rotating body and the second rotating body are linked together by using the planetary gear mechanism, which is an example of the gear mechanism. In this planetary gear mechanism, the plurality of pinion gears, which mesh simultaneously with the sun gear, are linked together concentrically by the carrier. In this planetary gear mechanism, the pinion gear may be referred to as a planetary gear and the ring gear may be referred to as an outer gear or an annular gear.

Even if a strong force acts between any of the plurality of pinion gears and the sun gear, the internal force that acts between the plurality of pinion gears and the sun gear acts so as to be cancelled out at the plurality of pinion gears. That is, the generation of a force that is biased toward any of the pinion gears is automatically suppressed.

In this wheel supporting and driving apparatus, the first rotating body is structured as one among the plurality of pinion gears that are linked together by the carrier, and thus, when this one pinion gear and the sun gear that corresponds to the second rotating body mesh together and rotate, even if a strong force acts therebetween, the generation of a force that is biased towards this one pinion gear is suppressed.

Therefore, according to this wheel supporting and driving apparatus, in spite of the first rotating body being biased toward the second rotating body, the mechanism that transfers the force between the first rotating body and the second rotating body can be readily mechanically stabilized.

In the wheel supporting and driving apparatus according to the fourth aspect, the first rotating body and the second rotating body are linked together by using the planetary gear mechanism, which is an example of the gear mechanism. In this planetary gear mechanism, the plurality of pinion gears, which mesh simultaneously with the ring gear, is linked together concentrically by the carrier. In this planetary gear mechanism, the pinion gear may be referred to as a planetary gear and the ring gear may be referred to as an outer gear or an annular gear.

Even if a strong force acts between any of the plurality of pinion gears and the sun gear, the internal force that acts between the plurality of pinion gears and the ring gear acts so as to be cancelled out at the plurality of pinion gears. That is, the generation of a force that is biased toward any of the pinion gears is automatically suppressed.

In this wheel supporting and driving apparatus, the first rotating body is structured as one among the plurality of pinion gears that are linked together by a carrier, and thus, when one among the pinion gears and the ring gear, which corresponds to the second rotating body, mesh together and rotate, even if a strong force acts therebetween, the generation of a force that is biased towards this one pinion gear is suppressed.

Therefore, according to this wheel supporting and driving apparatus, in spite of the first rotating body being biased toward the second rotating body, the mechanism that transfers the force between the first rotating body and the second rotating body can be readily mechanically stabilized.

In the wheel supporting and driving apparatus according to the fifth aspect, the structure that links the motor and the first rotating body together can be more readily simplified than the case in which the motor is linked non-coaxially with the first rotating body.

In the wheel supporting and driving apparatus according to the seventh aspect, the rotation and the reciprocating swinging of the steerable wheel are realized by the motor. Furthermore, during the steering of the vehicle, the motor and a first rotating body integrally rotate with the steerable wheel. Therefore, during steering, the angle formed between the axis of rotation of the motor and the axis of rotation of the first rotating body remains unchanged.

In contrast, in the case in which the transfer of the rotation between the two axes that cross to form a given angle is carried out via a universal joint, generally, the range of variation of the angle between these two axes is limited to a certain range in order to ensure the transfer efficiency.

Thus, the wheel supporting and driving apparatus according to any one of the first to fifth aspects is a mode in which the angle formed between the axis of rotation of the motor and the axis of rotation of the first rotating body varies while steering the vehicle. In spite of this angle variation, because the transfer of the rotation between the motor and the first rotating body is carried out with a high efficiency, in the case in which these aspects are implemented by a mode in which the motor and the first rotating body are linked together via a universal joint, the maximum value of the angle during steering is limited, and thus the maximum value of the steering angle of the wheel is also limited.

In contrast, in an alternative wheel supporting and driving apparatus, the angle formed by the axis of rotation of the motor and the axis of rotation of the first rotating body does not vary while steering. Therefore, it is possible to avoid a situation in which the maximum value of the steering angle of the wheel is limited in order to avoid a reduction in the transfer efficiency of the rotation between the motor and the first rotating body.

The “motor and first rotating body” in this section are, for example, supported by the vehicle body so as to rotate integrally with the steerable wheel during the steering of the vehicle within a plane that is parallel to the horizontal plane of the wheel.

In the wheel supporting and driving apparatus according to the eighth aspect, if the output torque of the motor is controlled, the swinging characteristics of the wheel are controlled. If these swinging characteristics are controlled, for example, it is possible to control the bounce and/or rebound characteristics of the wheel while the vehicle is driving. If these bounce and/or rebound characteristics are controlled, it is possible to improve the feel of the ride of the vehicle that is influenced by the vibrations of the wheels and the ability of the wheels to follow irregularities in the road surface.

For example, when the wheel travels over discontinuous sections on the road surface, such as projections, level differences, and the like, a strong force is abruptly applied from the road surface to the vehicle body, and after passing over the discontinuous section, a phenomenon in which the wheels continue to vibrate occurs readily. It is possible to implement the wheel supporting and driving apparatus according to this section in a mode in which the output torque of the motor is controlled with the object of suppressing this phenomenon.

According to the wheel supporting and driving apparatus according to the ninth aspect, in order to attenuate the vibrations that are generated at the wheel, it is necessary that a shock absorber, which attenuates the vibrations, be mounted on the vehicle. Furthermore, in order to control the damping characteristics of the wheel that is moving vertically with respect to the vehicle body, mounting an actuator, in addition to the motor, that applies a reciprocating swinging to this wheel on the vehicle is not necessary.

An example of the “wheel drive torque control unit” in the tenth aspect suppresses the vibrations of the wheels that are caused by the vehicle traveling so as to pass over the discontinuous section in the road surface as described above, and thereby, the feel of the ride of the vehicle and the ability of the wheels to follow the road surface are improved.

### BRIEF DESCRIPTION OF THE DRAWINGS

FIG. 1 is a side view that shows the mechanical structure of a wheel supporting and driving apparatus 10 according to a first embodiment of the present invention;

FIG. 2 is a block diagram that shows the electrical structure of the wheel supporting and driving apparatus 10 shown in FIG. 1;

FIG. 3 is a flowchart conceptually representing a level difference drive over control program that is stored in the ROM 66 in FIG. 2;

FIGS. 4A, 4B, and 4C are tables and side views for explaining each of the modes of the level difference drive over control program that is shown in FIG. 3;

FIG. 5 is a side view that shows the mechanical structure of a wheel supporting and driving apparatus 110 according to a second embodiment of the present invention;

FIG. 6 is a front view that shows the wheel supporting and driving apparatus 110 shown in FIG. 5;

FIG. 7 is a plane view that shows the wheel supporting and driving apparatus 110 shown in FIG. 5;

FIGS. 8A and 8B are plane views for explaining the steering state of the vehicle in which the wheel supporting and driving apparatus 110 shown in FIG. 5 is mounted;

FIG. 9 is a side view that shows the mechanical structure of a wheel supporting and driving apparatus 200 according to a third embodiment of the present invention;

FIG. 10 is a front view that shows the wheel supporting and driving apparatus 200 shown in FIG. 9; and

FIG. 11 is a plane view that shows the wheel supporting and driving apparatus 200 shown in FIG. 9.

### DETAILED DESCRIPTION OF THE PREFERRED EMBODIMENTS

Below, several more specific embodiments of the present invention will be explained in detail with reference to the drawings.

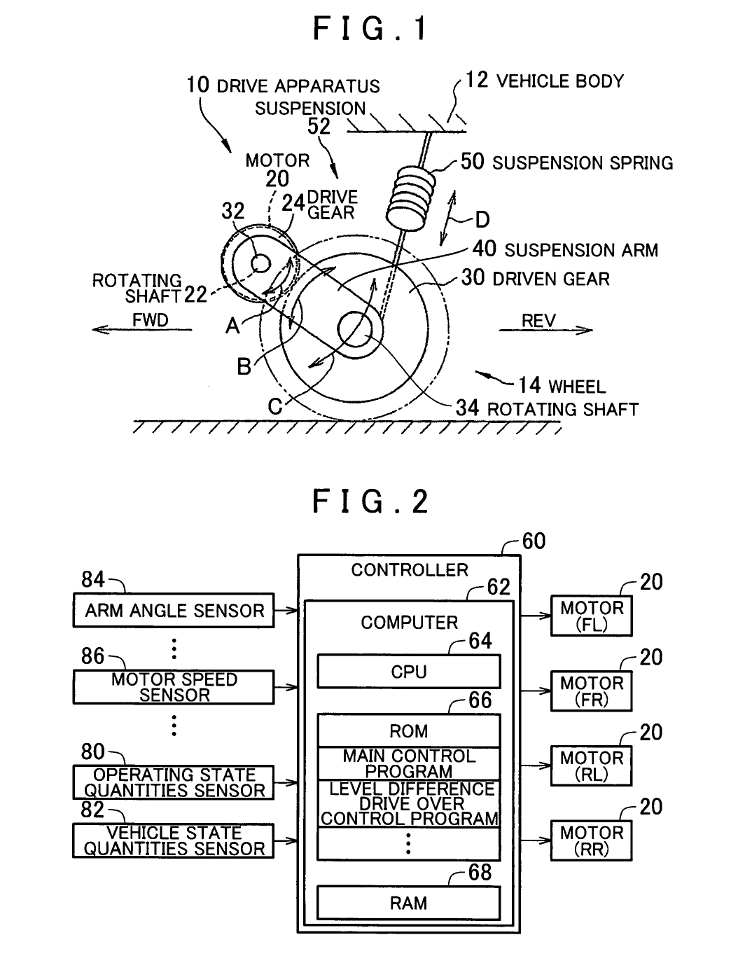

In FIG. 1, the mechanical structure of a wheel supporting and driving apparatus 10 according to a first embodiment is shown in a side view. However, the wheel 14 is shown as a phantom portion. This wheel supporting and driving apparatus 10 is mounted on a vehicle 14 that is provided with a vehicle body 12 and a plurality of wheels 14, which include left and right front wheels and left and right rear wheels. In FIG. 1, the wheel supporting and driving apparatus 10 is shown so as to focus on one of these wheels 14.

As shown in FIG. 1, each of the wheels of this wheel supporting and driving apparatus 10 is provided with a motor 20 that is fixed to the vehicle body 12 and a drive gear 24 that is linked coaxially with a rotating shaft 22 of this motor 20. The center of rotation of this drive gear 24 is decentered from the center of rotation of the wheel 14 in a direction that crosses the vertical direction. In the present embodiment, the motor 20 is supported by the vehicle body 12 such that substantially no displacement relative to the vehicle body 12 occurs in any direction. The drive gear 24 can rotate (autorotate) in both of the directions that are shown by the arrow A in FIG. 1.

In contrast, in the wheel 14, a driven gear 30 that meshes with and is driven by the drive gear 24 is coaxially provided. The wheel 14 rotates integrally with this driven gear 30. The driven gear 30 can rotate (autorotation) in both of the directions shown by the arrow B in FIG. 1.

Each of the wheels 14 of this wheel supporting and driving apparatus 10 is further provided with suspension arms 40 that link together the rotating shaft 32 of the drive gear 24 and the rotating shaft 34 of the driven gear 30. Specifically, these suspension arms 40 link together the drive gear 24 and the driven gear 30 so as to mesh such that the driven gear 30 can reciprocatingly swing around the drive gear 24 so as to define a constant radius. Therefore, the center of rotation of a wheel 14 and the center of rotation of a driven gear 30, which coincide with each other, can swing (autorotation) in both of the directions shown by the arrow C in FIG. 1 around the center of rotation of the drive gear 24.

As shown in FIG. 1, each of the wheels 14 of this wheel supporting and driving apparatus 10 is provided with a suspension spring 50. This suspension spring 50 elastically links the vehicle body 12 and a wheel 14 together. This suspension spring 50 compresses and expands in both of the directions that are shown by the arrow D in FIG. 1 accompanying the reciprocating swinging (movement that includes vertical motion) of the wheel 14. Due to this suspension spring 50, the elastic reciprocating swinging of the wheel 14, for which the center of rotation of the drive gear 24 serves as a center of swinging, is realized.

Therefore, in the present embodiment, the suspension arms 40 and the suspension spring 50 cooperate to form the suspension 52 of the wheel 14.

In FIG. 2, the electrical structure of this wheel supporting and driving apparatus 10 is conceptually represented by a block diagram. This wheel supporting and driving apparatus 10 is provided with a controller 60. This controller 60 is mainly formed by a computer 62, and, as is well-known, this computer 62 is structured by a CPU 64, ROM 66, and RAM 68, which are connected together by a bus (not illustrated).

As shown in FIG. 2, the motor 20 of each of the wheels 14 is further connected to the controller 60. In FIG. 2, FL denotes the motor for the front left wheel, FR denotes the motor for the front right wheel, RL denotes the motor for the rear left wheel, and RR denotes the motor for the rear right wheel.

An operation state quantities sensor 80 is connected to the controller 60, and detects the operation state quantities that are input via operation members (for example, an accelerator operation member, a brake operation member, a steering operation member, and the like) from an operator of the vehicle. Additionally, a vehicle state quantities sensor 82 is also connected to this controller 60, and detects the operating state quantities (for example, the speed, the forward and reverse acceleration rate, the lateral acceleration of the vehicle, and the like).

An arm angle sensor 84 for each of the wheels 14 that detects the angle of the suspension arms 40 is connected to the controller 60, and is an example of a sensor that detects a quantity of the state of the vertical movement of the wheel 14 with respect to the vehicle body 12. In addition, a motor speed sensor 86 for each of the wheels 14, which detects the rotational speed of the motor 20, is also connected to the controller 60, and is an example of a sensor that detects the quantity of the rotational state of the motor 20.

If a wheel 14 moves vertically with respect to the vehicle body 12, not only does the angle of the suspension arms 40 vary accompanying this movement, but the rotational speed of the motor 20 also varies because the rotational speed of the drive gear 24 varies due to the swinging of the driven gear 30. By focusing on this fact, in the present embodiment, an arm angle sensor 84 and a motor speed sensor 86 are used in order to detect the quantity of the state of the vertical movement of a wheel 14 with respect to the vehicle body 12. However, in order to attain this object, it is possible to use one of either the arm angle sensor 84 or the motor speed sensor 86 in conjunction with other sensors (for example, a sensor that detects the stroke of the suspension spring 50).

As shown in FIG. 2, various types of programs are stored in advance in the ROM 66, including, for example, a main control program and a level difference drive over control program. These programs are executed by the CPU 64 using the RAM 68.

Because the main control program is not necessary for understanding the present invention, it is not illustrated and will be briefly explained. This main control program is executed in order to control the horizontal movement of the vehicle by independently controlling the motors 20 in each of the wheels 14 based on the operation state quantities that have been detected by the operation state quantities sensor 80 and the vehicle state quantities that have been detected by the vehicle state quantities sensor 82, so as to reflect the intentions of the driver.

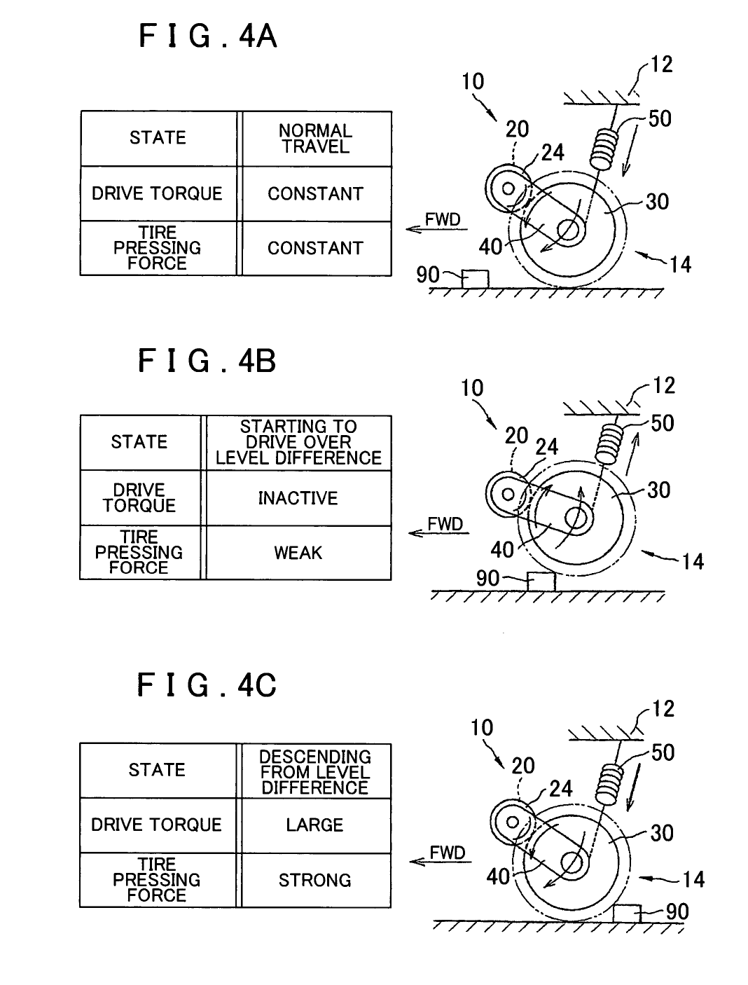

In contrast, the level difference drive over control program is executed in order to control the reciprocating swinging characteristics, that is, the bounce and rebound characteristics, of each of the wheels 14 by independently controlling the motors 20 of each of the wheels 14 such that large vibrations or continuous vibrations do not occur in the wheels 14 due to the input to the wheel 14 from the road surface when traveling such that the wheel 14 is passing over discontinuous sections such as level differences, protrusions and the like (below, for the convenience of explanation, these are referred to as a “level difference 90” (refer to FIG. 4)) in the road surface. The drive torque of each of the wheels 14 is actively controlled by the execution of this level difference drive over control program.

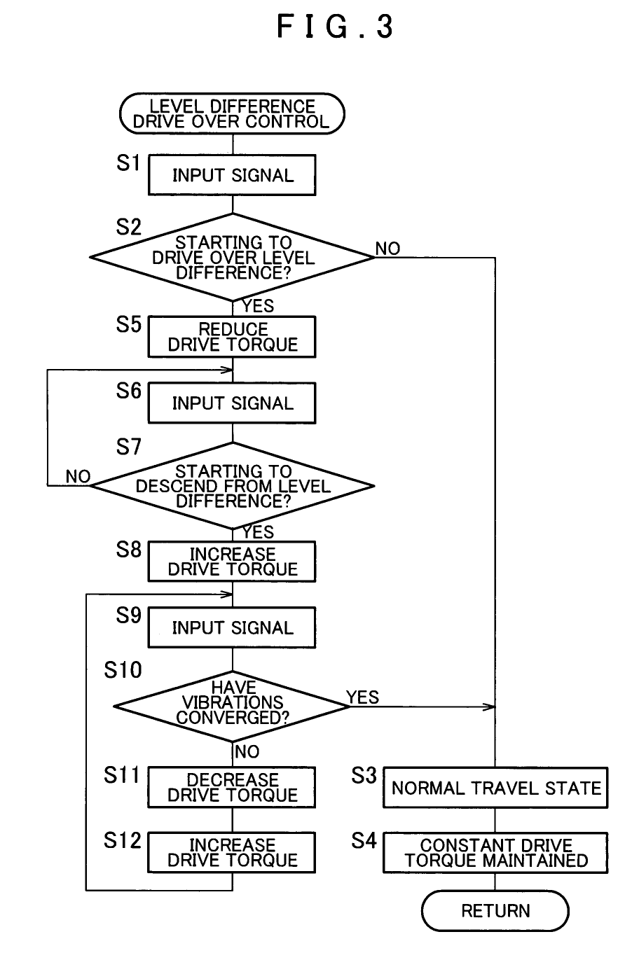

In FIG. 3, this level difference drive over control program is conceptually illustrated by a flowchart. While the vehicle is traveling, this level difference drive over control program is repeatedly executed in each of the wheels 14. Each time this program is executed, first, in step S1 (below, simply expressed as “S1”, and similarly for the other steps), detection signals that represent each of the detected results are input from the arm angle sensor 84 and the motor speed sensor 86 that are associated with a wheel 14 currently being controlled.

Next, in S2, based on these input detection signals, it is determined whether or not the wheel 14 currently being controlled has started to drive over the level difference 90 on the road surface. For example, in the case in which it has been detected that the suspension arms 40 have rotated around the center of rotation of the drive gear 24 more than a given angle from the neutral position shown in FIG. 1 in a direction that approaches the vehicle body 12 (the counterclockwise direction in the figure), it is determined that the wheel 14 currently being controlled is starting to drive over the level difference 90.

In the case in which the wheel 14 currently being controlled is not starting to drive over the level difference 90, the determination of S2 becomes NO, and in S3, it is determined that the wheel 14 currently being controlled in a normal travel state.

Subsequently, in S4, the normal control mode is selected, and as shown in FIG. 4A, the drive signal of the motor 20 is controlled such that a constant drive torque (the torque that acts on the wheel 14 to cause the positive rotation of the wheel 14) for the wheel 14 currently being controlled is maintained. As a result, for the wheel currently being controlled, a constant tire pressing force, by which the motor 20 presses the tire of the wheel 14 to the road surface, is maintained.

As shown in FIG. 4A, the drive torque of the motor 20 is mediated by a tangential force that acts on the sun gear 30 at the position where the input pinion 24 meshes with this sun gear 30, which is separated in the radial direction from the center of rotation of the input pinion 24. This drive torque of the motor 20, which is oriented so as cause the positive rotation of the wheel 14, is converted by this mediation to the swinging torque of the suspension arms 40 around the center of rotation of the input pinion 24 in a direction that separates the wheel 14 from the vehicle body 12. A tire pressing force, by which the motor 20 presses the tire of the wheel 14 onto the road surface, is generated by this converted swinging torque.

As a result of executing S5, S8, S11, and S12, which are described below, prior to the execution of S4, the drive torque of the wheel 14 currently being controlled may deviate from the value for normal travel. In this case, this drive torque is restored to the value for normal travel by the execution of the S4.

At this point, one execution of the level difference drive over control program ends.

Above, the case of the state in which the wheel 14 currently being controlled did not start to drive over the level difference 90 was explained, but in the case in which the wheel 14 starts to drive over the level difference 90, the determination of S2 in FIG. 3 becomes YES, and the processing moves to step S5. In S5, the level difference drive over start control mode is selected, and the drive signal for the motor 20 is controlled such that the drive torque acting on the wheel 14 currently being controlled is instantaneously reduced.

The drive torque acting on the wheel 14 currently being controlled is controlled such that, for example, as shown in FIG. 4B, the wheel 14 currently being controlled is instantaneously switched to an inactive state. In this case, the tire pressing force due to the motor 20 instantaneously becomes weaker than that during normal travel. Therefore, the wheel 14 currently being controlled more readily approaches the vehicle body 12 than during normal travel. As a result, in spite of the height of the level difference 90 that the wheel 14 currently being controlled is driving over, a large vertical movement is not generated.

Specifically, as shown in FIG. 4B, when the drive torque of the motor 20 that positively rotates the wheel 14 is instantaneously reduced, the swinging torque of the suspension arms 40, which separates the vehicle 14 from the vehicle body 12, is also instantaneously reduced. Due to this instantaneous reduction, the tire pressing force by which the motor 20 presses the tire of the wheel 14 to the road surface is also instantaneously reduced, and as a result, the wheel 14 more readily approaches the vehicle body 12 than during normal travel, and easily follows the upward slope of the level difference (projection) 90.

Subsequently, in S6 shown in FIG. 3, the detection signals from the arm angle sensor 84 and the motor speed sensor 86 are input, and next, in S7, based on these detection signals that have been input, it is determined whether or not the wheel 14 currently being controlled is starting to descend from the level difference 90 on the road surface. For example, in the case in which it is detected that the suspension arms 40 have rotated around the center of rotation of the drive gear 24 more than a given angle in a direction of separation from the vehicle body 12 (the clockwise direction in the figure), it is determined that this wheel 14 is starting to descend from the level difference 90.

In the case in which the wheel 14 currently being controlled is not starting to descend the level difference 90, the determination of S7 becomes NO, and the processing returns to S6, whereas in the case in which the wheel 14 has started to descend the level difference 90, the determination in S7 becomes YES.

Subsequently, in S8, the level difference descent start mode is selected, and as shown in FIG. 4C, the drive signal for the motor 20 is controlled such that the drive torque that acts on the wheel 14 currently being controlled is instantaneously increased to a value that is larger than the value during normal travel. In this case, the tire pressing force due to the motor becomes stronger than that during normal travel. As a result, the force that separates the wheel 14 currently being controlled from the vehicle body 12 in increased to a level that is higher than that during normal travel. Thereby, in spite of the height of the level difference 90 that the wheel 14 currently being controlled is descending, a large vertical movement is not generated in the vehicle body 12.

Specifically, as shown in FIG. 4C, when the drive torque of the motor 20 that positively rotates the wheel 14 instantaneously increases, the swinging torque of the suspension arms 40 that separate the wheel 14 from the vehicle body 12 also instantaneously increases. Due to this instantaneous increase, the tire pressing force by which the motor 20 presses the tire of the wheel 14 to the road surface is also instantaneously increased, and as a result, the wheel 14 more readily separates from the vehicle body 12 than during normal travel, and the wheel 14 easily follows the descending slope of the level difference (projection) 90.

Next, in S9 shown in FIG. 3, the detection signals from the arm angle sensor 84 and the motor speed sensor 86 are input, and subsequently, in S10, based on the detection signals that have been input, it is determined whether or not the vibrations of the wheel 14 currently being controlled have converged within a permitted range. For example, in the case in which the amount of fluctuation over time of the angle of the suspension arms 40, which has been detected by the arm angle sensor 84, has become equal to or less than a reference value, and/or the amount of fluctuation over time of the rotation speed of the motor 20, which has been detected by the motor speed sensor 86, has become equal to or less than a reference value, it is determined that the vibrations of this wheel 14 have converged within a permitted range.

In the case in which the vibrations of the wheel 14 currently being controlled have converged to within a permitted range, the determination of S10 becomes YES, and the processing proceeds to step S3. However, in the case in which the vibrations have not converged, the determination of S10 becomes NO, and the processing proceeds to S11. In S11, the drive torque is instantaneously reduced, and next, in S12, the drive torque is instantaneously increased. The increases and decreases in the drive torque executed in S11 and S12 are preferably carried out as far as possible so as to be in synchrony with the vertical movement of the wheel 14 currently being controlled. Due to these increases and decreases in the drive torque, the vibration of the wheel 14 currently being controlled is gradually attenuated. Thereby, even after the wheel 14 has driven over the level difference 90, the phenomenon in which the vehicle body 12 vibrates is suppressed.

If the vibrations of the wheel 14 currently being controlled converge to within a permitted range as a result of repeatedly executing S9 through S12 several times, the determination of S10 becomes YES, and after executing S3 and S4, one execution of this level difference drive over control program ends.

As has been made clear from the above explanation, in the present embodiment, the drive gear 24 forms an example of the “first rotating body” that is disclosed in the above section (1), the driven gear 30 forms an example of the “second rotating body” that is disclosed in the same section, the suspension arms 40 form a first linking structure, and the suspension spring 50 forms an example of the “second linking mechanism” that is disclosed in the same section.

Furthermore, in the present embodiment, the wheel 14 shown in FIG. 1 forms an example of a “nonsteerable wheel” that is disclosed in the above section (6), the controller 60 forms an example of the “control apparatus” that is disclosed in the above section (8), and in the controller 60, the section that executes the level difference drive over control program shown in FIG. 3 forms an example of the “wheel drive torque controlling unit” that is disclosed in the above section (10).

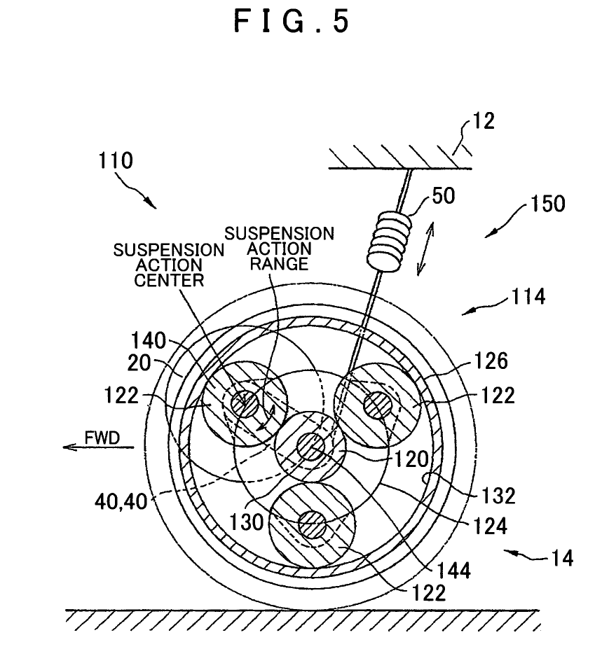

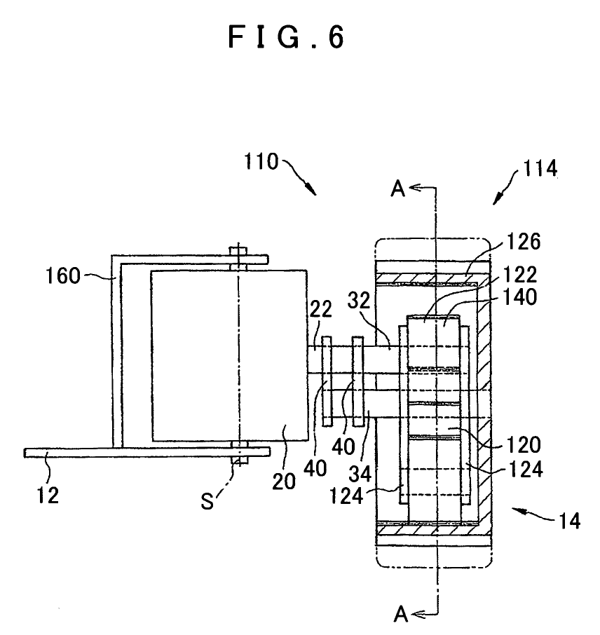

Next, a second embodiment of the present invention will be explained. FIG. 5 is a side view in which the motor side is viewed in cross-section along line A-A in FIG. 6. However, in the present embodiment, only the mechanical structure differs from the first embodiment, and thus, because the electrical structure is common, only the mechanical structure will be explained. While a detailed explanation of the electrical system is omitted, parts thereof are denoted by using identical reference numerals and names.

In the first embodiment, the rotational torque of the motor 20 is transferred to the wheel 14 by a gear train in which the drive gear 24 that is coaxial with the motor 20 and the driven gear 30 that is coaxial with the wheel 14 mesh together. In contrast, in a wheel supporting and driving apparatus 110 according to this embodiment, as shown in FIG. 5, the rotational torque of the motor 20 is transferred to the wheel 14 by a planetary gear mechanism 114.

As is well known, a planetary gear mechanism 114 is structured so as to include a sun gear 120, a plurality of pinion gears 122, 122, and 122, a carrier 124, and a ring gear 126. In the present embodiment the sun gear 120 rotates coaxially and integrally with the wheel 14, as shown in FIG. 5. The ring gear 126 is linked to the hub via a bearing or the like on the outer circumference thereof, and rotates relative to the wheel 14. The sun gear 120 and the ring gear 126 rotate in opposite directions.

The plurality of pinion gears 122, 122, and 122 are disposed so as to be arranged on a circle that is coaxial with the sun gear 120. These pinion gears 122, 122, and 122 are disposed so as to mesh with the outer teeth 130 of the sun gear 120, and mesh with the inner teeth 132 of the ring gear 126. This plurality of pinion gears 122, 122, and 122 is retained by the carrier 124 such that the relative positional relationships between the centers of rotation of the plurality of pinion gears 122, 122, and 122 are maintained.

One among the plurality of pinion gears 122, 122, and 122 is selected to be the input pinion 140, and the motor 20 is coaxially linked to this input pinion 140. No relative angular displacement occurs between the input pinion 140 and the motor 20, and the motor 20 is supported on the vehicle body 12 so as to be immobile in at least the vertical direction. In addition, no relative angular displacement occurs between the input pinion 140 and the carrier 124, and the carrier 124 is supported so as to be able to reciprocatingly swing with the wheel 14, with the center of rotation of the motor 20 and the input pinion 140 serving as the center of swinging.

As shown in FIG. 5, the suspension spring 50 elastically links together the vehicle body 12 and the wheel 14 (for example, the rotation shaft 144 of the sun gear 120 or the portion of the suspension arms 40 that reciprocatingly swings along with the reciprocating swinging of the wheel 14).

The wheel 14 reciprocatingly swings centered on the center of rotation of the motor 20, that is, the center of rotation of the input pinion 140. Due to this reciprocating swinging, the vertical movement of the wheel 14 with respect to the vehicle body 12 is realized. In the present embodiment, the suspension arms 40 and the suspension spring 50 cooperate to form the suspension 150 of the wheel 14.

The center of swinging of the wheel 14 coincides with the center of rotation of the motor 20, that is, the center of rotation of the input pinion 140, and these centers of rotation function as a center of action of the suspension 150. Accompanying the swinging of the wheel 14, the suspension arms 40 are selectively rotated in a direction in which the wheel 14 approaches the vehicle body 12 from the neutral position shown in FIG. 5, and a direction in which the wheel 14 separates from the vehicle body 12 from the neutral position shown in FIG. 5, and the range of this angle of rotation is equivalent to the range of action of the suspension 150.

In FIG. 6, the wheel supporting and driving apparatus 110 is shown in a front view in relation to the wheel 14, which is a steerable wheel among the steerable wheels and the nonsteerable wheels in the vehicle. However, the wheel 14 and the ring gear 126 are shown in a vertical cross-sectional view that includes the rotating central shaft 34 of the wheel 14. Thus, in the wheel supporting and driving apparatus 110 that is shown in FIG. 6, the motor 20 is attached to the vehicle body 12 by a fixed frame 160 so as to be immobile in the vertical direction, whereas the motor 20 is installed so as to be able to rotate around the axis of rotation S that extends substantially in a vertical direction. Due to this rotation, the swinging, that is, the steering, of the wheel 14 in a horizontal plane, and thus the steering of the vehicle, are realized. This means that the axis of rotation S is the center of steering of the wheel 14.

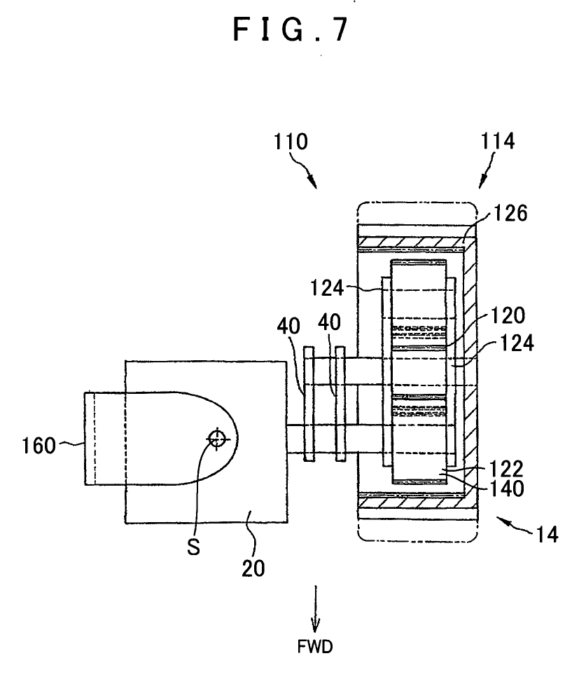

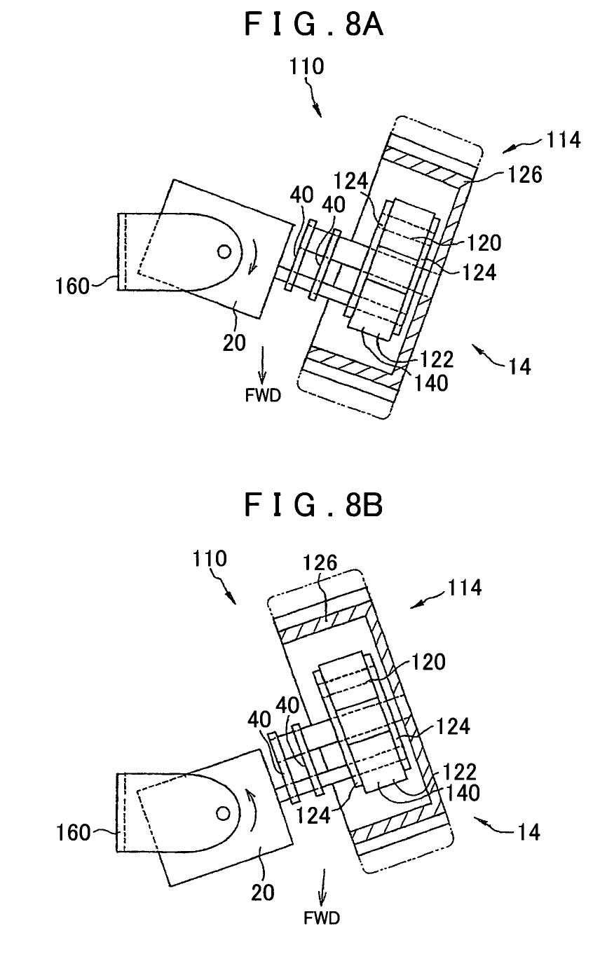

In FIG. 7, the wheel supporting and driving apparatus 110 that is shown in FIG. 6 is shown in a plane view while the vehicle is moving straight forward. In FIG. 8A, the wheel supporting and driving apparatus 110 is shown while the vehicle is turning right, and in FIG. 8B, it is shown while the vehicle is turning left. Each of these drawings is a substantially plane view. However, the wheel 14 and the ring gear 126 are shown in a horizontal cross-sectional view that includes the rotating center shaft 34 of the wheel 14.

Therefore, in the present embodiment, during the bounce and rebound of a wheel 14, the wheel 14 moves vertically while the motor 20 and the input pinion 140 remain stationary, whereas during the steering of the wheel 14, the wheel 14 rotates in a horizontal plane integrally with the motor 20 and the input pinion 140.

As is clear from the above explanation, in the present embodiment, the input pinion 140 forms an example of the “first rotating body” that is disclosed in the above section (1), the sun gear 120 forms an example of the “second rotating body” that is disclosed in the same section, the suspension arms 40 form an example of the “first linking mechanism” that is disclosed in the same section, and the suspension spring 50 forms an example of the “second linking mechanism” that is disclosed in the same section.

Furthermore, in the present embodiment, the wheel 14 forms an example of the “steerable wheel” that is disclosed in the above section (7), and the motor 20 and the input pinion 140 form an example of the “motor and first rotating body” that are disclosed in the same section.

Note that as an alternative embodiment, in the planetary gear mechanism 114, the sun gear 120 may be rotated relative to the wheel 14, and the ring gear 126 may be rotated integrally with the wheel 14. The drive force of the motor 20 is transferred to the hub and the wheel 14 from the input pinion 140 via the ring gear 126. Because the sun gear 120 idles, the sun gear 120 and the rotating center shaft 34 of the wheel 14, and the wheel 14 and the rotating center shaft 34 of the wheel 14 may be linked via a bearing or the like.

In the present embodiment, the input pinion 140 forms an example of the “first rotating body” that is disclosed in the above section (1), and the ring gear 126 forms an example of the “second rotating body” that is disclosed in the same section.

Next, a third embodiment of the present invention will be explained. However, in the present embodiment, only the mechanical structure differs from the second embodiment, and thus, because the electrical structure is common, only the mechanical structure will be explained. Although the detailed explanation of the electrical system is omitted, portions thereof are denoted by using identical reference numerals and names.

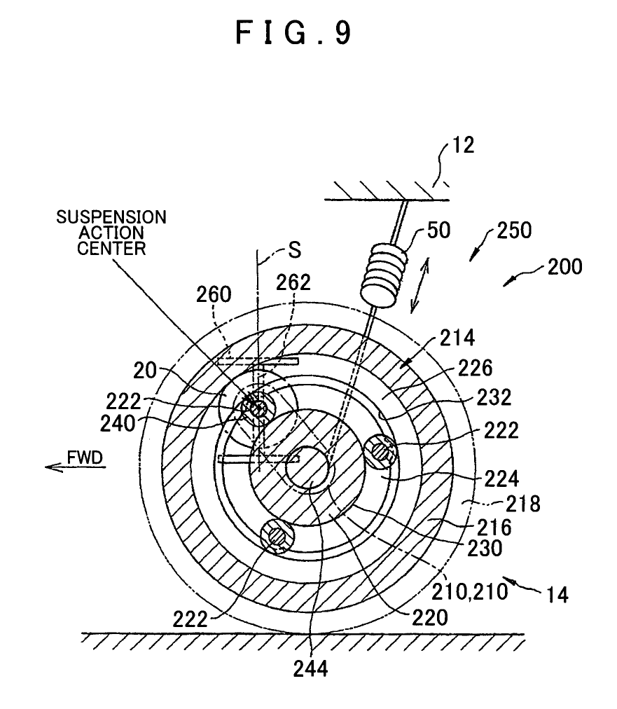

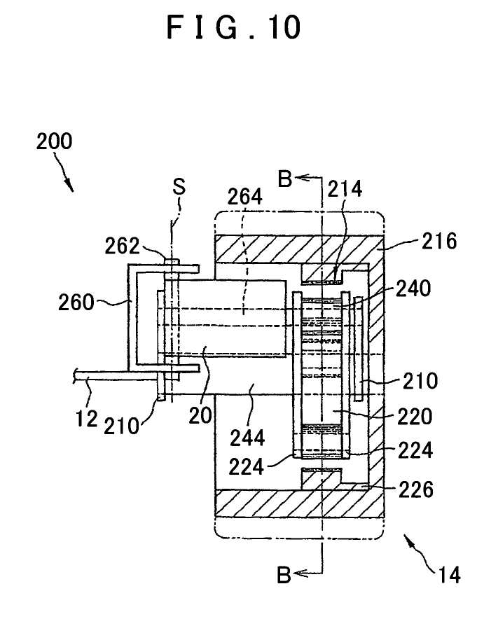

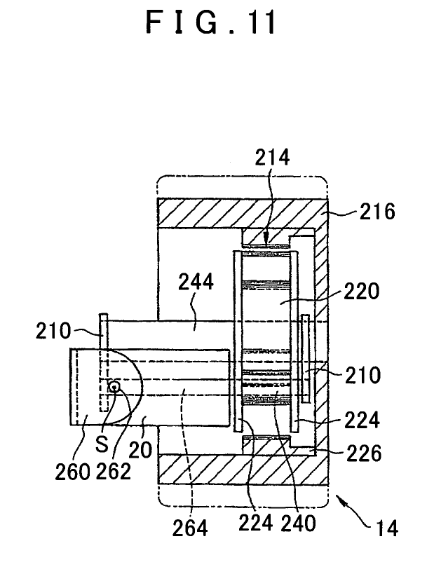

In FIG. 9 to FIG. 11, a wheel supporting and driving apparatus 200 according to the present embodiment is shown, respectively, from a side view, a front view, and a plane view. Furthermore, FIG. 9 is a side view in which the motor side is viewed in cross-section along line B-B in FIG. 10. In addition, the wheel 14 and a ring gear 226 in FIG. 10 are shown in a vertical cross-section that includes the rotating center shaft 34 of the wheel 14, and the wheel 14 and the ring gear 226 in FIG. 11 are shown in a horizontal cross-section that includes the rotating center shaft 34 of the wheel 14.

As shown in FIG. 9, the wheel 14 is structured by a rubber tire 218 that is mounted on the outside of a metal hub 216. Air is sealed inside this tire 218 under pressure.

As shown in FIG. 10, a planetary gear mechanism 214 is disposed inside the hub 216. A portion of the motor 20 in the axial direction, that is, the end portion among the two end portions of the housing of this motor 20 that is close to the planetary gear mechanism 214, is also disposed inside the hub 216. Therefore, the overall dimensions of the motor 20 and the hub 216 in the axial direction can readily be reduced in comparison to the case in which the overall dimension of the motor 20 in the axial direction is disposed outside the hub 216.

As shown in FIG. 9, the planetary gear mechanism 214, similar to the second embodiment, is structured so as to include a sun gear 220, a plurality of pinion gears 222, 222 and 222, a carrier 224, and the ring gear 226. The sun gear 220 rotates coaxially and integrally with the wheel 14. The ring gear 266 is linked to the hub 216 via a bearing or the like on the outer circumference thereof, and is rotated relative to the wheel 14. The sun gear 220 and the ring gear 226 rotate in opposite directions.

The plurality of pinion gears 222, 222, and 222 is disposed so as to be arranged on a circle that is coaxial with the sun gear 220, and they are disposed so as to mesh with outer teeth 230 of the sun gear 220 and mesh with inner teeth 232 of the ring gear 226. The plurality of pinion gears 222, 222, and 222 is retained by the carrier 224.

One of the plurality of pinion gears 222, 222, and 222 is selected to be an input pinion 240, and the motor 20 is coaxially linked to this input pinion 240. No relative angular displacement occurs between the input pinion 240 and the motor 20, and the motor 20 is supported so as to be immobile in at least the vertical direction on the vehicle body 12. In addition, no relative angular displacement occurs between the input pinion 240 and the carrier 224, and the carrier 224 is supported so as to be able to reciprocatingly swing with the wheel 14, with the rotating shaft 32 of the motor 20 and the input pinion 240 serving as center of swinging.

As shown in FIG. 9, the suspension spring 50 elastically links together the vehicle body 12 and the wheel 14 (for example, a rotating shaft 244 of the sun gear 220 or the portion of suspension arms 210 that reciprocatingly swings along with the reciprocating swinging of the wheel 14).

The wheel 14 reciprocatingly swings with the center of rotation of the motor 20, that is, the center of rotation of the input pinion 240 serving as the center of swinging. Due to this reciprocating swinging, the vertical movement of the wheel 14 with respect to the vehicle body 12 is realized. In the present embodiment, the suspension arms 210 and the suspension spring 50 cooperate to form a suspension 250 of the wheel 14.

The center of swinging of the wheel 14 coincides with the center of rotation of the motor 20, that is, the center of rotation of the input pinion 240, and these centers of rotation function as a center of action of the suspension 250. Accompanying the swinging of the wheel 14, the suspension arms 210 are selectively rotated in a direction in which the wheel 14 approaches the vehicle body 12 from the neutral position shown in FIG. 9 and a direction in which the wheel 14 separates from the vehicle body 12 from the neutral position shown in FIG. 9.

In FIG. 10, the wheel supporting and driving apparatus 200 is shown in a front view in relation to a wheel 14, which is a steerable wheel among the steerable wheels and the nonsteerable wheels in the vehicle. Thus, in the wheel supporting and driving apparatus 200 that is shown the figure, the motor 20 is attached to the vehicle body 12 by a fixed frame 260 so as to be immobile in the vertical direction, whereas the motor 20 is installed so as to be able to rotate around an axis of rotation S that extends substantially in a vertical direction via a swinging shaft 262 that extends substantially perpendicularly. Due to this rotation, the swinging, that is, the steering, of the wheel 14 in a horizontal plane, and thus the steering of the vehicle, are realized.

As shown in FIG. 10, the pair of suspension arms 210 and 210 oppose each other separated by a gap in the direction of the axis of rotation of the motor 20 so as to surround the motor 20 and the planetary gear mechanism 214.

Specifically, the rotating shaft 264, which straddles the motor 20 and the input pinion 240, passes through the same axis, and a pair of suspension arms 210 and 210 are suspended between the rotating shaft 264 and the rotating shaft 244 of the sun gear 220. One of the suspension arms 210 (shown on the left side in FIG. 10) links the end portion of the rotating shaft 264 that projects from the motor 20 to the side opposite to the wheel 14 and the end portion of the rotating shaft 244 that projects from the sun gear 220 to the side opposite to the wheel 14 and so as to be able to rotate while maintaining a constant distance. The other suspension arm 210 (shown on the right side in FIG. 10) links the end portion of the rotating shaft 264 that projects from the input pinion 240 to the side opposite to the motor 20 and the end portion of the rotating shaft 244 that projects from the sun gear 220 to the side opposite to the motor 20 so as to be able to rotate while maintaining a constant distance.

A comparison between the present embodiment and the second embodiment described above will be explained. As shown in FIG. 6, in the second embodiment, the rotation torque of the motor 20 is transferred to the wheel 14 by the planetary gear mechanism 114. In the second embodiment, the rotating shaft 22 of the motor 20 and the rotating shaft 32 of the input pinion 140 (the rotating shafts 22 and 32 are integrally formed), and the rotating shaft 144 of the sun gear 120 are connected together by the pair of suspension arms 40 and 40.

As shown in FIG. 6, in the second embodiment, the suspension arms 40 and 40 are disposed together inside the space between the wheel 14 and the motor 20. In contrast, in the wheel supporting and driving apparatus 200 according to the present embodiment, as shown by the front view in FIG. 10, the pair of suspension arms 210 and 210 are disposed so as to surround the motor 20 and the planetary gear mechanism 214 that is disposed inside the wheel 14.

Therefore, according to the present embodiment, the suspension arms 210 and 210 are to be linked together between the motor 20 and input pinion 240, and the sun gear 220, and in the axial direction of the two parallel rotating shafts 244 and 264, the suspension arms 210 and 210 oppose each other at a greater distance than in the second embodiment.

Thus, according to the present embodiment, because the two rotating shafts 244 and 264 are linked together such that the distance and the parallelism between these two rotating shafts 244 and 264 are maintained, the rigidity and thickness of each of the suspension arms 210 and 210 do not need to be increased to the levels of the suspension arms 40 and 40 in the second embodiment.

As shown in FIG. 6, in the second embodiment, the entire motor 20 is disposed outside the wheel 14. In contrast, in the present embodiment, as shown in FIG. 10, at least a portion of the motor 20 in the axial direction is disposed inside the wheel 14.

Therefore, according to the present embodiment, the motor 20 and the wheel 14 are easily disposed more tightly and compactly in the vehicle than is the case in the second embodiment, and the size of the wheel supporting and driving apparatus 200 can be readily reduced. Furthermore, in addition to this, according to the present embodiment, the axis of rotation S of the wheel 14, which is a steerable wheel, can readily be made to approach the wheel 14. Here, the axis of rotation S is a steering center (king pin axis).

As is clear from the above explanation, in the present embodiment, the input pinion 240 forms an example of the “first rotating body” that is disclosed in the above section (1), the sun gear 220 forms an example of the “second rotating body” disclosed in the same section, the pair of suspension arms 210 and 210 form an example of the “first linking mechanism” that is disclosed in the same section, and the suspension spring 50 structures an example of the “second linking mechanism” that is disclosed in the same section.

Furthermore, in the present embodiment, the wheel 14 forms an example of the “steerable wheel” that is disclosed in the above section (6), and the motor 20 and the input pinion 240 form an example of the “motor and first rotating body” that is disclosed in the same section.

Note that in an alternative embodiment of the planetary gear mechanism 214, the sun gear may be rotated relatively to the wheel 14 and the ring gear 226 may rotate integrally with the wheel 14. The drive force of the motor 20 is transferred to the wheel 14 from the input pinion 240 via the ring gear 226. Because the sun gear 220 idles, a bearing or the like can be used to link the sun gear 220 to the rotating shaft 244 and the wheel 14 to the rotating shaft 244.

In this embodiment, the input pinion 240 forms an example of the “first rotating body” that is disclosed in the above section (1), and the ring gear 226 forms an example of the “second rotating body” that is disclosed in the same section.

Furthermore, any of the embodiments that have been explained above can be modified into a mode in which, while the vehicle is traveling, the displacement speed in the vertical direction, that is, the vertical stroke speed, of the wheel 14 can be detected by a sensor. Using, for example, the arm angle sensor 84, this vertical stroke speed can be detected as a time integrated value of the angle that is detected by this arm angle sensor 84.

In this mode, furthermore, based on this detected vertical stroke speed, the drive signal of the motor 20 is controlled by the controller 60 such that the output torque of the motor 20, and thus, the drive torque of the wheel 14, are controlled. By using this mode, for vehicle travel, it is possible to carry out variable control of the damping characteristics of the suspensions 52, 150, and 250 by using the motor 20 that rotates and drives the wheel 14.

Above, several embodiments of the present invention have been explained with reference to the figures. However, these are merely examples, and including the modes disclosed in the “Summary of the Invention”, the present invention may be practiced in various alternative modified and improved modes based on the knowledge of persons skilled in the art.

### INDUSTRIAL APPLICABILITY

In the wheel supporting and driving apparatus of the present invention, the rotation (autorotation) of the wheel and the reciprocating swinging (revolution) around the center of rotation of the first rotating body of the same wheel are realized by the same motor. The rotation of the wheel contributes to the travel (drive) of the vehicle, whereas the reciprocating swinging of the wheel contributes to the suspension ability of the vehicle. The characteristics of this reciprocating swinging can be controlled by this motor. Furthermore, in this wheel supporting and driving apparatus, the wheel is elastically linked to the vehicle body by the second linking mechanism.

Thus, according to this wheel supporting and driving apparatus, it is possible to realize a suspension ability that suspends the vehicle body on the wheels so as to be able to move at least in the vertical direction due to the cooperation of the reciprocating swinging of the wheel and the control of the characteristics thereof by the motor, and due to the wheels being elastically linked to the vehicle body.

Specifically, according to this wheel supporting and driving apparatus, it is possible to realize the vehicle drive ability and the suspension ability together by the same motor, and thus, in comparison to the case in which these abilities are realized by separate actuators, the structure necessary for realizing these abilities can be easily simplified.

1. A wheel supporting and driving apparatus that is provided on a vehicle, that supports a wheel so as to be able to move vertically with respect to a vehicle body, and that drives the wheel, comprising:
a motor that is supported by the vehicle body;
a first rotating body that is rotated by the motor;
a second rotating body that rotates coaxially and integrally with the wheel;
a first linking mechanism that links the first rotating body and a rotating center shaft of the wheel such that the wheel reciprocatingly swings around a center of swinging, where a center of rotation of the first rotating body serves as the center of swinging; and
a second linking mechanism that elastically links the wheel and the vehicle body;
wherein the first rotating body is rotated by the motor around a center of rotation that is decentered from a center of rotation of the wheel in a direction that is perpendicular to the vertical direction.

2. The wheel supporting and driving apparatus according to claim 1, wherein:
the first rotating body is a drive gear;
the second rotating body is a driven gear that meshes with and is rotated by the drive gear;
the first linking mechanism includes a suspension arm that links the drive gear and the driven gear in a meshed state such that the driven gear can reciprocatingly swing around the drive gear so as to define a constant radius; and
the second linking mechanism includes a suspension spring that elastically links the wheel and the vehicle body together.

3. The wheel supporting and driving apparatus according to one of claim 1 and claim 2, comprising:
a sun gear that rotates coaxially and integrally with the wheel;
a ring gear that rotates coaxially with and relatively to the wheel;
a plurality of pinion gears that are disposed so as to be arranged on a circle that is concentric with the sun gear, and the plurality of pinion gears meshes with the outer teeth of the sun gear and meshes with the inner teeth of the ring gear; and
a carrier that retains the plurality of pinion gears so as to maintain the relative positional relationships between centers of rotation of the plurality of pinion gears, wherein
a planetary gear mechanism is formed by the sun gear, the ring gear, the plurality of pinion gears, and the carrier;
the first rotating body is structured by one among the plurality of pinion gears; and
the second rotating body is structured by the sun gear.

4. The wheel supporting and driving apparatus according to claim 1, comprising:
a sun gear that rotates coaxially and integrally with the wheel;
a ring gear that rotates coaxially with and relatively to the wheel;
a plurality of pinion gears that are disposed so as to be arranged on a circle that is concentric with the sun gear, and the plurality of pinion gears meshes with the outer teeth of the sun gear and meshes with the inner teeth of the ring gear; and
a carrier that retains the plurality of pinion gears so as to maintain the relative positional relationships between centers of rotation of the plurality of pinion gears, wherein
a planetary gear mechanism is formed by the sun gear, the ring gear, the plurality of pinion gears, and the carrier;
the first rotating body is structured by one among the plurality of pinion gears; and
the second rotating body is structured by the ring gear.

5. The wheel supporting and driving apparatus according to claim 4, wherein the motor is coaxially linked to the first rotating body.

6. The wheel supporting and driving apparatus according to claim 5, wherein the wheel is a nonsteerable wheel that is not steered while steering the vehicle; and
the motor and the first rotating body are supported on the vehicle body at a fixed position.

7. The wheel supporting and driving apparatus according to claim 5, wherein the wheel is a steerable wheel that is steered while steering the vehicle; and
the motor and the first rotating body are supported by the vehicle body so as to be integrally rotated with the steerable wheel while steering the vehicle.

8. The wheel supporting and driving apparatus according to claim 7, comprising a control apparatus that controls the output torque of the motor by controlling a drive signal to the motor.

9. The wheel supporting and driving apparatus according to claim 8, wherein the control apparatus comprises a damping characteristic control unit that controls damping characteristics of the wheel during vertical movement with respect to the vehicle body by controlling swinging characteristics of the wheel around the center of swinging thereof via the motor.

10. The wheel supporting and driving apparatus according to claim 9, wherein the control apparatus comprises a wheel drive torque control unit that controls the drive torque of the wheel around the center of rotation thereof via the motor.

11. The wheel supporting and driving apparatus according to claim 2, comprising:
a sun gear that rotates coaxially and integrally with the wheel;
a ring gear that rotates coaxially with and relatively to the wheel;
a plurality of pinion gears that are disposed so as to be arranged on a circle that is concentric with the sun gear, and the plurality of pinion gears meshes with the outer teeth of the sun gear and meshes with the inner teeth of the ring gear; and
a carrier that retains the plurality of pinion gears so as to maintain the relative positional relationships between centers of rotation of the plurality of pinion gears, wherein
a planetary gear mechanism is formed by the sun gear, the ring gear, the plurality of pinion gears, and the carrier;
the first rotating body is structured by one among the plurality of pinion gears; and
the second rotating body is structured by the ring gear.

12. The wheel supporting and driving apparatus according to claim 11, wherein the motor is coaxially linked to the first rotating body.

13. The wheel supporting and driving apparatus according to claim 1, wherein the motor is coaxially linked to the first rotating body.

14. The wheel supporting and driving apparatus according to claim 2, wherein the motor is coaxially linked to the first rotating body.

15. The wheel supporting and driving apparatus according to claim 3, wherein the motor is coaxially linked to the first rotating body.

16. The wheel supporting and driving apparatus according to claim 1, wherein the wheel is a nonsteerable wheel that is not steered while steering the vehicle; and
the motor and the first rotating body are supported on the vehicle body at a fixed position.

17. The wheel supporting and driving apparatus according to claim 1, wherein the wheel is a steerable wheel that is steered while steering the vehicle; and
the motor and the first rotating body are supported by the vehicle body so as to be integrally rotated with the steerable wheel while steering the vehicle.

18. The wheel supporting and driving apparatus according to claim 1, comprising a control apparatus that controls the output torque of the motor by controlling a drive signal to the motor.

19. The wheel supporting and driving apparatus according to claim 18, wherein the control apparatus comprises a damping characteristic control unit that controls damping characteristics of the wheel during vertical movement with respect to the vehicle body by controlling swinging characteristics of the wheel around the center of swinging thereof via the motor.

20. The wheel supporting and driving apparatus according to claim 8, wherein the control apparatus comprises a wheel drive torque control unit that controls the drive torque of the wheel around the center of rotation thereof via the motor.
